(19) United States
(12) Patent Application Publication
(10) Pub. No.: US 2017/0342095 A1
(43) Pub. Date: Nov. 30, 2017

(54) ORGANOFUNCTIONAL SILICON PARTICLES, PROCESS FOR THE PRODUCTION THEREOF AND USE THEREOF

(71) Applicant: Evonik Degussa GmbH, Essen (DE)

(72) Inventors: Juergen Erwin LANG, Karlsruhe (DE); Bodo FRINGS, Schloss Holte Stukenbrock (DE); Michael KROELL, Linsengericht (DE); Goswin UEHLENBRUCK, Oberursel (DE)

(73) Assignee: Evonik Degussa GmbH, Essen (DE)

(21) Appl. No.: 15/604,187

(22) Filed: May 24, 2017

(30) Foreign Application Priority Data
May 25, 2016 (EP) 16171252.6

(51) Int. Cl. C07F 7/08; C09K 15/32; B01F 17/54; B01J 19/08; C01B 33/029

(52) U.S. Cl. CPC C07F 7/0827; B01J 19/081; C01B 33/029; B01F 17/0071; C09K 15/328; B01J 2219/0875; B01J 2219/0896

(57) ABSTRACT

Organofunctional silicon particles are covalently functionalized on their surface with at least one organic compound, for example a plurality of —O—(C₁-C₄₈)-alkyl compounds. The functionalization of the surface of the silicon particles makes it possible to adjust the properties of fluids in terms of their profile of properties by addition of the modified silicon particles. For instance, the alkoxy-functionalized silicon particles may preferably be added to a motor oil as additives for reducing viscosity.

### BACKGROUND OF THE INVENTION

### Field of the Invention

The invention relates to organofunctional silicon particles covalently functionalized on their surface with at least one organic compound. Thus, the organofunctional silicon particles may for example be functionalized on their surface with a plurality of —O—(C₁-C₄₈)-alkyl compounds. The functionalization of the surface of the silicon particles makes it possible to adjust the properties of fluids in terms of their profile of properties by addition of the organofunctionally modified silicon particles. For instance, the alkoxy-functionalized silicon particles may preferably be added to a motor oil as additives for reducing viscosity.

### DETAILED DESCRIPTION OF THE PREFERRED EMBODIMENTS

The viscosity of a lubricating oil is one of the most important properties when choosing a suitable lubricant. If for example a plain bearing is to run in the range of liquid friction in order to allow virtually wear-free operation, the choice of the correct viscosity allows the thickness of the lubricating film to be adjusted. This is chosen such that there is no danger of small external changes causing the bearing to run in the range of mixed friction which could lead to premature component failure. However, at the same time the chosen lubricating film should not be too thick either. In this case, safe operation would be possible but the coefficient of friction would be higher than necessary.

The viscosity index (VI), introduced in the USA in 1928, has gained acceptance in the field of lubrication technology for describing the temperature-viscosity dependence. The baselines used were the base oil at that time having the greatest temperature dependence, assigned the value VI=0, and the oil having the smallest temperature dependence, assigned the value VI=100.

The pressure dependence of viscosity may be estimated with the Barus equation (n(p)=n⁰*exp(a*p)). Here, n⁰ is viscosity at 1 bar, a is a viscosity pressure coefficient and p is pressure. In metal forming, lubricants may be under such high stress that viscosity increases by several powers of ten.

There is also a need for further UV filters with very good UV protection properties which are based on inorganic materials and at the same time shall be readily incorporable into normally organic matrices of a formulation.

### SUMMARY OF THE INVENTION

It is accordingly an object of the present invention to provide an additive which can reduce the viscosity of lubricants while simultaneously having high heat stability. It is in particular an object of the invention to provide an additive which does not evaporate and/or does not decompose even at relatively high temperatures. The additive shall preferably be heat stable and not evaporate up to about 300° C. It is likewise an object of the invention to provide an additive or a lubricant which combines the properties of two separate lubricating oils—a low viscosity without for example evaporating at higher temperatures according to the invention. The additive shall furthermore bring about a corresponding change in the properties of the respective matrix even in very small quantities. It is moreover an independent object of the invention to provide an additive which is employable in UV protection formulations and can be homogeneously distributed therein.

In one embodiment, the present invention relates to organofunctional silicon particles, comprising:

silicon particles which are covalently functionalized on their surface with at least one organic compound.

In another embodiment, the present invention relates to a process for producing organofunctional silicon particles covalently functionalized on their surface with at least one organic compound, comprising:
a) decomposing at least one gaseous or gaseous-at-elevated-temperature silicon compound
b) in the presence of a diluent gas in a substantially oxygen-free atmosphere in plasma or under thermal conditions, and
c) immediately introducing the silicon particles formed into at least one fluid organic starting compound or into a mixture comprising the at least one organic starting compound.

The present invention also relates to a composition, comprising:

the above organofunctional silicon particles as an additive or auxiliary in liquids, in liquid compositions, in pastes or pasty compositions, in emulsions, dispersions, suspensions, solutions, or gases.

### BRIEF DESCRIPTION OF THE DRAWINGS

FIG. 1a.1 shows a plasma reactor 2b.

FIG. 1a.2 shows a plasma reactor 2b with reactor 9 comprising the fluid organic compound.

FIG. 1b shows a thermal reactor with millichannels.

FIG. 2a shows a pure paraffin oil test series.

FIG. 2b shows paraffin oil with 0.5% Si-isopropanol test series.

FIG. 3 shows a plot of dynamic viscosity as a function of shear rate (A: paraffin oil without additive, B: paraffin oil with 0.5 wt % of functionalized silicon particles, in each case d=0 mm).

### DETAILED DESCRIPTION OF THE INVENTION

The invention proceeds from, for example, treating a monosilane mass flow in such a way that the intermediate, in particular the silicon particles obtainable in situ in the process, are sent to an absorptive purification and/or conversion. The mass flow which preferably comprises 1.6 vol % of SiH₄ in an argon matrix and was processed and brought to reaction in a plasma discharge in non-thermal equilibrium comprises silicon particles having a highly reactive surface. In terms of the action of the plasma treatment it is believed that the kinetics are favored such that by plasmachemical means silicon ions which selectively substitute hydrogen at the corresponding silicon compounds are formed, resulting according to the invention in a silicon nanoparticle radical. The radicals make the mass flow amenable to a reactive absorptive workup, in particular the absorptive workup functionalizes the surface of the silicon particles with at least one organic compound by chemisorption of liquid organic compounds, in particular by chemisorption.

In a further, preferred variant of the plasma generation the volume flow is sent to a so-called “dielectric barrier discharge under standard conditions” and brought to reaction there in a non-thermal plasma. It is known to one skilled in the art that dielectric barrier discharges are utilized in industry in so-called ozonizers. The plasma reactor is preferably operated at full conversion. A process is considered operated at full conversion when the reactant is converted to an extent greater than 95 vol %. The hydrogen liberated is preferably withdrawn from the process as pure product. In addition, the silicon particles are moreover removed from the argon matrix by reactive chemisorption in a further step. The argon may be recovered in the residual gas.

For the known principles of gas discharge and plasma chemistry, reference is made to the relevant technical literature: for example A. T. Bell “Fundamentals of Plasma Chemistry” ed. J. R. Hollahan and A. T. Bell, Wiley, New York (1974).

In the process according to the invention after the chemisorption the mass flow is amenable to a simple workup, such as filtration, by means of which the pure product can be preferentially withdrawn. Residual gas generated which, as well as argon and H₂, may also comprise monosilane may be subjected to a separation and monosilane thus obtained can be recycled.

The invention provides organofunctional silicon particles covalently functionalized on their surface with at least one organic compound. These organofunctional silicon particles may be present as primary particles and/or as agglomerates and/or as aggregates. Furthermore, the primary particle size of the functionalized silicon particles may be in the range from 1 nm to 5000 nm, in particular the primary particle size of the silicon particles is from 10 nm to 2000 nm. In addition, the primary particle size of the pure silicon particles, neglecting the organic compounds which form the outer shell of the silicon particles, may be from 1 nm to 5000 nm; the primary particle sizes are preferably 10 nm to 250 nm. Furthermore, the preferred primary particle sizes of the functionalized silicon particles are preferably in the range of an average median primary particle size of d₅₀=1 nm to 200 nm, in particular of d₅₀=1 to 100 nm, preferably of d₅₀=1 to 10 nm, d₅₀=5 to 10 nm and/or d₅₀=16 to 40 nm or mixtures of these primary particle sizes. The silicon particles comprise—neglecting the functionalization—95.0 to 99.99 wt % of silicon.

According to a particularly preferred alternative, the silicon particles organofunctional on their surface with an organic compound comprise at least one organic compound having a molecular weight of not more than 800 g/mol, preferably of 30 to 800 g/mol, in particular 600 g/mol; the molecular weight is preferably not more than 450 g/mol, more preferably not more than 250 g/mol, not more than 150 g/mol, not more than 100 g/mol. Organic compounds are to be understood as including polymers and monomers, monomers being preferred as organic compound. According to the invention, polymers are to be understood as not including decomposition products but rather including only polymers obtainable undecomposed by polymerization from monomeric compounds such as (meth)acrylates. Preferred organic starting compounds, synonymous with the liquid organic compound, which are used for functionalization of the silicon particles and form the organic compound preferably comprise organic solvents, protic organic compounds, such as protic solvents, amino acids, carboxylic acids, fatty acids, fruit acids, etc. The protic organic starting compounds may be present as a pure liquid starting compound or as a melt of the starting compound or else may be present in an inert matrix.

Particularly preferred functionalized silicon particles are obtainable by introducing the reactive silicon particles obtainable in situ in a plasmachemical process, in particular in non-thermal plasma, and/or under thermal conditions into a liquid, protic organic starting compound, in particular water-free liquid, protic, organic starting compound. The liquid, protic, organic starting compound preferably serves to functionalize the silicon particles with an organic compound. Furthermore, organofunctional silicon particles are obtainable by introducing the reactive silicon particles obtainable in situ in a plasmachemical process into at least one liquid hydrocarbon and/or a liquid mixture comprising a protic, organic starting compound and a hydrocarbon. According to the invention, liquid organic starting compounds are to be understood as including organic starting compounds which are present as a gas or liquid at 1 bar and a temperature of not more than 100° C. or which may be converted undecomposed into the liquid phase, for example into the melt or gas phase, at a pressure of 10⁻⁵ bar to less than 1 bar and a temperature below 100° C. Preferred liquid organic starting compounds include organic starting compounds which are present as a gas, melt, liquid, in particular in a solution, suspension, emulsion, dispersion at 1 bar and a temperature of less than 100° C. or which may be converted undecomposed into the gas phase or which may be converted into the liquid phase at 1 bar and a temperature of less than 100° C.

The invention further provides organofunctional silicon particles functionalized with at least one organic compound, wherein the organic compound, in particular —R, is selected from oxygen-comprising organic compounds, nitrogen-comprising organic compounds, sulfur-comprising organic compounds, halogen-comprising organic compounds or at least oxygen-, nitrogen- and/or sulfur-comprising organic compounds; the organic compound is in particular selected from unsubstituted hydrocarbons, substituted hydrocarbons, carbohydrates, alcohols, in particular —O radical, —O-alkyl, thiolene, in particular —S radical, —S-alkyl, ethers, in particular —O-ether radical, amino acids, in particular —N radical, polyethers, in particular —O-polyether radical, halogenated hydrocarbons, halogenated alcohols, halogenated polyethers, carboxylic acid, in particular —OCO radical, fatty acids, in particular —OCO fatty acid radical, fruit acids or the respective radicals; the organic compound is preferably selected from —O-hydrocarbons, pure hydrocarbons, partly halogenated or perhalogenated hydrocarbons, partly halogenated or perhalogenated polyethers or the respective radicals thereof with which the surface of the silicon particles is functionalized. Alcohols are to be understood as including unsubstituted alcohols of hydrocarbons and partly halogenated and perhalogenated alcohols, such as HO—C₂F₅, HO—CₙHal₂ₙ₊₁ or else HO—C₂F₄—O—C₂F₄—C₂F₅, HO—CₙHal₂ₙ-O—CₙHal₂ₙ₊₁, where Hal is bromine, chlorine, fluorine or iodine, in each case independently where n is 0 to 20, in particular where n is 1 to 10.

The invention further provides organofunctional silicon particles functionalized with at least one organic compound, wherein the at least one organic compound is preferably a monomeric organic compound.

The organofunctionally surface-modified silicon particles comprise Si—R components in which the Si atom represents a multiplicity of silicon atoms in the surface of the silicon particles and —R represents an organic compound covalently bonded to the silicon atom.

The reaction may be exemplarily represented as follows where X—R is organic starting compound, X=leaving groups and R=organic compound:

Si particle-Si—H+X—R→Si particle-Si—R+HX

A sketch of an organofunctional Si particle is shown below:

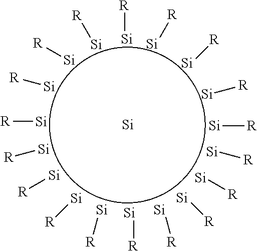

The invention likewise provides organofunctional silicon particles, wherein the at least one organic compound, in particular R, is selected from

—O—(C₁-C₄₈)-alkyl, —O—(C₆-C₂₀)-aryl, —O—(C₁-C₄₈)-alkyl-(C₆-C₂₀)-aryl,

—O—(C₆-C₂₀)-aryl-(C₁-C₄₈)-alkyl, —(C₆-C₂₀)-aryl, —O—(C₁-C₁₂)-alkyl-O—(C₁-C₁₂)-alkyl,

—O—(C₁-C₁₂)-alkyl-O—(C₆-C₂₀)-aryl, —O—(C₆-C₂₀)-aryl-O—(C₁-C₁₂)-alkyl,

—O—(C₆-C₂₀)-aryl-O—(C₆-C₂₀)-aryl, —OC═O—(C₁-C₁₂)-alkyl, —S-alkyl, —S-aryl, —COO—(C₁-C₁₂)-alkyl,

—CONH—(C₁-C₁₂)-alkyl, —CO—(C₁-C₁₂)-alkyl, —CO—(C₆-C₂₀)-aryl,

—N[(C₁-C₁₂)-alkyl]₂, —(C₁-C₄₈)-alkyl, —(C₆-C₂₀)-aryl, —(C₁-C₄₈)-alkyl-(C₆-C₂₀)-aryl, —(C₆-C₂₀)-aryl-(C₁-C₄₈)-alkyl, wherein the alkyl and aryl groups may each independently be unsubstituted or substituted; substituted —(C₁-C₁₂)-alkyl groups and substituted —(C₆-C₂₀)-aryl groups may, depending on their chain length, comprise one or more substituents; the substituents may independently of one another be selected from —(C₃-C₁₂)-cycloalkyl, —(C₃-C₁₂)-heterocycloalkyl, —(C₆-C₂₀)-aryl, fluorine, chlorine, bromine, cyano, formyl, acyl or alkoxycarbonyl. The alkyl groups may in each case be linear, branched and/or cyclic.

In a particularly preferred embodiment, preference is given to organofunctional silicon particles where the at least one organic compound is selected from —O—(C₁-C₄₈)-alkyl, —O—(C₆-C₂₀)-aryl, —O—(C₁-C₄₈)-alkyl-(C₆-C₂₀)-aryl, —O—(C₆-C₂₀)-aryl-(C₁-C₄₈)-alkyl, —(C₆-C₂₀)-aryl, —O—(C₁-C₁₂)-alkyl-O—(C₁-C₁₂)-alkyl, —O—(C₁-C₁₂)-alkyl-O—(C₆-C₂₀)-aryl, —O—(C₆-C₂₀)-aryl-O—(C₁-C₁₂)-alkyl, —O—(C₆-C₂₀)-aryl-O—(C₆-C₂₀)-aryl, —(C₁-C₄₈)-alkyl, —(C₆-C₂₀)-aryl, —(C₁-C₄₈)-alkyl-(C₆-C₂₀)-aryl, —(C₆-C₂₀)-aryl-(C₁-C₄₈)-alkyl, wherein the alkyl and aryl groups are each independently unsubstituted or partly halogenated to perhalogenated, in particular the halogen in partly halogenated to perhalogenated alkyl and/or aryl groups is selected from fluorine, chlorine or bromine, preferably from fluorine and chlorine.

It is particularly preferable when the at least one organic compound with which the silicon particles are functionalized is selected from —O—(C₁-C₄₈)-alkyl, in particular selected from —O—(C₁-C₁₂)-alkyl; the organic compound is particularly preferably selected from —OCH₃, —OC₂H₅, —O—C₃H₇, —O—C₄H₉, —O—O₅H₁₁, —O—C₆H₁₃, —O—C₇H₁₅, —O—C₈H₁₇—O—C₉H₁₉, —O—C₁₀H₂₁, —O—C₁₁H₂₃, —O—C₁₂H₂₃, preferably —O-(iso-C₃H₇) —O-(n-C₃H₇), —O—C₄H₉, —O-(n-C₄H₉), —O-(iso-C₄H₉), —O-(tert-C₄H₉), —O—C₄H₉. The alkyl chains may be linear, branched or cyclic.

According to a further preferred alternative, the surface of the silicon particles may have a coverage factor Θ with the at least one organic compound (chem. adsorbed molecules N_{ads}) of 10 to 100 based on a monolayer coverage (Nₘₒₙₒ), in particular the coverage factor Θ is 20 to 100, preferably 25 to 80. The coverage factor Θ is the ratio of the number of molecules, i.e. the number of molecules of the organic compound, chemically adsorbed N_{ads} to the number of molecules for complete coverage of the surface (“monolayer coverage” Nₘₒₙₒ): Θ=N_{ads}/Nₘₒₙₒ.

The invention likewise provides a process in which preferably monosilane but optionally also a disilane or trisilane is subjected to a gas discharge and the solid silicon formed having a particle size in the nanometer range, in particular of 1 to 1000 nm, is intermediately captured or removed by absorptive means. The silicon particles preferably comprise not less than 90 to 99.9999 wt % of silicon, in particular 95 to 99.99 wt % of silicon, more preferably from 98 to 99.9999 wt % of silicon.

The invention likewise provides a process for producing organofunctional silicon particles, and organofunctional silicon particles obtainable by the process, wherein the organofunctional silicon particles are covalently functionalized on their surface with at least one organic compound, where
a) at least one gaseous or gaseous-at-elevated-temperature silicon compound
b) is decomposed in the presence of a diluent gas in a substantially oxygen-free atmosphere in plasma or under thermal conditions, and
c) the silicon particles formed are immediately introduced into at least one organic starting compound, in particular into a fluid organic starting compound, preferably into a fluid, water-free, organic starting compound, or into a liquid mixture comprising the at least one organic starting compound to preferably obtain the organofunctional silicon particles.

According to a preferred process variant, the organic starting compound, in particular X—R, where x=H, is selected from HO—(C₁-C₄₈)-alkyl, HO—(C₆-C₂₀)-aryl,

HO—(C₁-C₄₈)-alkyl-(C₆-C₂₀)-aryl, HO—(C₆-C₂₀)-aryl-(C₁-C₄₈)-alkyl,

HO—(C₁-C₁₂)-alkyl-O—(C₁-C₁₂)-alkyl, HO—(C₁-C₁₂)-alkyl-O—(C₆-C₂₀)-aryl,

HO—(C₆-C₂₀)-aryl-O—(C₁-C₁₂)-alkyl, HO—(C₆-C₂₀)-aryl-O—(C₆-C₂₀)-aryl,

HOC═O—(C₁-C₁₂)-alkyl, HS-alkyl, HS-aryl, H—COO—(C₁-C₁₂)-alkyl, H—CONH—(C₁-C₁₂)-alkyl, H—CO—(C₁-C₁₂)-alkyl, H—CO—(C₆-C₂₀)-aryl, H—N[(C₁-C₁₂)-alkyl]₂, (C₁-C₄₈)-alkyl, (C₆-C₂₀)-aryl, (C₁-C₄₈)-alkyl-(C₆-C₂₀)-aryl, (C₆-C₂₀)-aryl-(C₁-C₄₈)-alkyl, wherein the alkyl and aryl groups may each independently be unsubstituted or substituted; substituted —(C₁-C₁₂)-alkyl groups and substituted —(C₆-C₂₀)-aryl groups may, depending on their chain length, comprise one or more substituents; the substituents may independently of one another be selected from —(C₃-C₁₂)-cycloalkyl, —(C₃-C₁₂)-heterocycloalkyl, —(C₆-C₂₀)-aryl, fluorine, bromine, chlorine, cyano, formyl, acyl or alkoxycarbonyl. HO—(C₁-C₄₈)-alkyl and O—(C₁-C₄₈)-alkyl may be halogenated.

According to the invention, it is preferable when the silicon particles formed in situ are brought into contact with a fluid, water-free, organic starting compound or a fluid mixture comprising the organic starting compound or a mixture comprising the fluid starting compound. The silicon particles formed in situ are preferably introduced into a fluid, water-free, organic starting compound or a fluid mixture comprising the organic starting compound or a mixture comprising the fluid starting compound.

The temperature of the organic starting compound in the process according to the invention is preferably −273° C. to 250° C., in particular at a pressure of 10⁻⁵ bar to 100 bar_{abs.}, preferably from −150° C. to 150° C. at 0.001 to 10 bar_{abs.}. More preferably the temperature is −50° C. to 100° C. at 0.001 to 5 bar_{abs.}, preferably 0° C. to 100° C. at 0.001 to 5 bar_{abs.}.

The molar ratio of the gaseous silicon compound to the diluent gas is preferably from 0.1 mol/100 mol of diluent gas to 50 mol/100 mol of diluent gas, preferably from 0.5 mol/100 mol of diluent gas to 2 mol of silicon/100 mol of diluent gas. It is particularly preferable to employ 1.6 vol %+/−0.5 vol % of silane in the diluent gas. The pressure is preferably from 0.1 to 2.5 bar_{abs.}, preferably at a temperature of about 20-120° C., 80-120° C. The molar ratio of silicon to diluent gas may be used to adjust the primary particle size and optionally the size of agglomerates and/or aggregates.

Generally, the introduction of the silicon particles, in particular the silicon particles obtainable in situ, into the organic starting compound may be effected when the starting compound has a temperature markedly below 250° C., preferably below 200° C., more preferably below 100° C., particularly preferably below 50° C. to −273° C. It is particularly preferable when the starting compound has a temperature of −10° C. to 50° C. Particular preference is given to a rapid introduction within one second, preferably within 1000 milliseconds after leaving the plasma and/or decomposition under thermal conditions, particularly preferably within not more than 200 milliseconds.

The gaseous or gaseous-at-elevated-temperature silicon compound according to the invention preferably comprises hydrogen-comprising silanes. Preferred silicon compounds include monosilane, disilane, trisilane and mixtures comprising at least one of the silanes or else a compound which is converted into the gas phase at elevated temperature and/or reduced pressure. Contemplated gaseous silicon compounds generally include all hydrogen-comprising silanes such as monosilane, disilane, trisilane and mixtures comprising at least one of the silanes and/or hydrocarbon-comprising silanes and also silanes and polysilanes comprising halogen and hydrogen or only halogen which may also be reacted in the process in admixture. The silicon compound may preferably include traces of Si—Cl, Si—Br and/or halosilanes or trace amounts of a Si—Cl-containing compound are added. The gaseous-at-elevated-temperature silicon compound may also include hydrocarbon-comprising silanes. Preferred silanes are halosilanes, chlorosilanes, such as dichlorosilane, trichlorosilane, tetrachlorosilane, hexachlorodisilane, methyltrichlorosilane, polyhalosilanes and pure H-silanes, such as monosilane, hydrogen-comprising polysilanes or polyhalosilanes and/or at least one alkoxysilane. Pure H-silanes are particularly preferred.

The diluent gas according to the invention or a mixture of diluent gases preferably comprises argon, helium, xenon, krypton, hydrogen or a mixture of at least two of the recited gases.

The plasma is preferably a non-thermal plasma, wherein the plasma in particular has a power density of 0.1 to 20 W/cm³, preferably of 10 to 20 W/cm³, particularly preferably of 15 to 20 W/cm³.

The reaction under thermal conditions, in particular comprising the decomposition and formation of the particles and the clusters, may be effected at temperatures above 150° C., preferably above 400° C. to 1500° C., to produce amorphous powders. To produce amorphous particles, short contact times, preferably at temperatures below 1300° C., are chosen. Alternatively, the formation of amorphous primary particles may be effected at temperatures of around 1300° C., preferably not more than 1100° C. The particles are deposited in a cooler zone of the reactor. Preferred contact times are from 10 to 600 milliseconds.

Typical conventional processes based on a reaction of SiCl₄ require 30 kW/kg or more for the reaction. The processes according to the invention are preferably based on a reaction of monosilane with an energy requirement of less than 10 kW/kg, particularly preferably around 5 kW/kg. Furthermore, for reaction in (cold) plasma the energy requirement is reduced further to less than 4 kW/kg.

A particular advantage of the process according to the invention is that when monosilane or hydrogen silanes, such as SiₙH₂ₙ₊₂, are used for producing the silicon particles no acid is formed during production of the silicon particles as is the case for production of silicon particles from halosilanes.

The invention likewise provides organofunctional silicon particles obtainable by the process according to the invention, where the organofunctional silicon particles are functionalized on their surface with at least one organic compound covalently and/or by chemisorption of an organic compound.

In a further embodiment, the invention in particular provides for the use of the organofunctional silicon particles or of the organofunctional silicon particles obtainable by the process according to the invention as an additive in a use according to a), b), c), d) and/or e). The invention further provides for the use of the organofunctional silicon particles or of the organofunctional silicon particles obtainable by the process according to the invention

a) as an additive for reducing the viscosity of fluids, in particular of liquids, such as lubricants, preferably of oils, which may preferably be present as solutions, emulsions, dispersions, suspensions, or as an additive for gases and/or b) for protection of industrial materials from electromagnetic radiation in the wavelength range of 10 to 1500 nm, and/or c) as UV protection for industrial materials, surfaces, components, optoelectronic layers, optoelectronic components, and/or d) as UV protection from electromagnetic radiation, and/or e) for protection of biological cells from electromagnetic radiation in the wavelength range of 10 to 1500 nm.

The invention likewise provides compositions comprising organofunctional silicon particles functionalized with at least one organic compound as an additive or auxiliary in at least one liquid, liquid composition, paste or pasty composition, emulsion, dispersion, suspension, solution, gas or mixtures of gases.

Compositions according to the invention include organofunctional silicon particles functionalized with at least one organic compound in oil, hydrocarbons, fat, wax, lubricant, halohydrocarbon, monomers, such as (meth)acrylate, gases. Particularly preferred compositions include motor oils, hydraulic oil, Teflon, lubricants, paraffin oil, coconut oil, mineral oils, synthetic motor oils, or else silicone sealants or else encapsulants for electronic components.

Preferred pure silicon particles, in particular primary particles, which may preferably be present as clusters, have a content of silicon of not less than 90 wt % to 100 wt % based on the silicon particle, in particular the content of silicon is not less than 55 wt %, preferably the silicon proportion is not less than 80 wt %, ≧95 wt %, ≧98 wt %, ≧99 wt %, ≧99.5 wt %, ≧99.99 wt %, ≧99.999 wt % to 100.0 wt %. The particles are preferably substantially amorphous. The content of oxygen is less than 50 wt % to 0.0 wt %, preferably less than 30 wt %, particularly preferably less than 10 wt % to 0.0 wt %, and may depend on the primary particle size. According to the invention, the content is determined by the surface to volume ratio.

The invention likewise provides for the use of the organofunctional silicon particles for absorption of electromagnetic radiation in the wavelength range of not less than 10 nm to 1100 nm, in particular in the wavelength range of 10 nm to 450 nm. The organofunctional silicon particles are preferably used as UV protection, preferably as UV protection in the wavelength range of 180 to 400 nm, particularly preferably of 200 to 380 or to 400 nm. It is likewise preferable that the organofunctional silicon particles can also provide protection from electromagnetic radiation in the wavelength range of the extreme UV such as 10 to 100 nm or to 120 nm, in the far UV from 200 to 280 nm, in the middle UV from 280 to 315 nm and/or in the near UV from 315 to 380 nm and, depending on particle size of the primary particles, from 400 to 750 nm in the visible range. The silicon particles may likewise optionally provide protection from electromagnetic radiation in the IR range above 750 nm to about 1500 nm. The defined absorption in the aforementioned ranges can be set specifically via the content of the respective median primary particle sizes.

Preference is further given to organofunctional silicon particles whose primary particles may have a median diameter d₅₀ (determined by TEM evaluation; TEM=transmission electron microscopy) in the range of 5 to 80 nm, preferably of 20 to 50 nm, in particular as in situ silicon primary particles, and which may preferably be present as aggregated clusters. The clusters can also be referred to as agglomerates, a cluster in the present case being understood to mean primary particles aggregated or fused to one another. For instance, the primary particles can form clusters in which at least two primary particles are fused to one another at their surfaces. These clusters may be present as linear chains, in the form of wires or else branched in 3-dimensional space.

Alternatively, the silicon particles may be obtained, in particular as in situ silicon particles, in a plasma in non-thermal equilibrium, the temperatures of which are not more than 1050° C., preferably not more than 700° C., particularly preferably not more than 150° C. In another variant, the preferred processing is in the low-temperature range, i.e. in the range of 373 Kelvin and greater than 0 Kelvin.

It is preferable in accordance with the invention when the plasma comprises the conditions of a gas discharge, in particular in non-thermal plasma.

Non-thermal plasmas used in accordance with the invention are produced, for example, by a gas discharge or by incidence of electromagnetic energy, such as by incidence of radio waves or microwaves, in a reaction chamber. The plasma is thus produced not by high temperatures as in the case of thermal plasmas, but by non-thermal ionization processes. One skilled in the art is aware of such plasmas. In this regard, what is called the Penning ionization process is cited by way of example.

For the processes detailed above, gas discharges operated in non-thermal equilibrium were used. Non-thermal in the sense of the invention means that the electrons as energy-imparting species have a higher temperature and hence a higher energy (kinetic energy) than the heavy particles (Si, SiH, SiH₂⁺ . . . C, H, H₂, . . . ). These can be produced by means of ballasts or power supply units known or familiar to one skilled in the art. The non-thermal plasma generally comprises electrons having an energy in the range of 0.1 to 100 eV, in particular of 1 to 50 eV, and heavy particles having an energy in the range of 0.000 001 to 10 eV, in particular 0.01 to 0.1 eV.

It has been found that, surprisingly, such a non-thermal gas discharge can advantageously be produced by dimming (phase gating control) and/or by pulse width modulation or via the pulse frequency, the electrodes advantageously being configured as hollow electrodes with preferably porous end faces, made from sintered metal for example, through a two-dimensional parabolic shape. Thus, the gas stream is distributed homogeneously over the electrode surface. The two-dimensional mushroom-like surface can be described by F(r)=r² (0.1<r<1.1 cm). The process according to the invention is generally conducted in non-thermal plasmas having temperatures of 100° C. to 3400° C., preferably of 700° C. to 999° C.

The plasma can be pulsed; preferably, an essentially cylindrical plasma, in particular non-thermal plasma, is provided in a cylindrical region of the reaction cylinder.

In the syntheses in plasma an inert gas, for example a noble gas or a mixture of noble gases, for example argon with small proportions of helium, and/or krypton, xenon, and/or reactive gases such as nitrogen, hydrogen, methane, carbon tetrachloride, etc. may advantageously be employed. Other gas mixtures are known to one skilled in the art or may be found in relevant textbooks.

A further preferred embodiment of the process according to the invention includes the introduction of noble gas or of noble gas mixtures or of noble gas/gas mixtures composed of the combination argon and/or helium, krypton, xenon as diluent gas and optionally reactive gases such as nitrogen, hydrogen, methane, carbon tetrachloride, etc. into the non-thermal plasma which in particular has temperatures of not more than 3000° C., preferably not more than 500° C., particularly preferably not more than 100° C. to −100° C.

A further preferred embodiment of the process according to the invention includes the introduction of noble gas or of noble gas mixtures as diluent gas into the non-thermal plasma which in particular has temperatures of not more than 1500° C., preferably not more than 300° C., particularly preferably not more than 300° C. to 100° C.

The particle size determination of the silicon particles and the formation of clusters such as agglomerates or the presence of primary particles may be determined analytically by the following methods. The particle size may be determined by methods including sieve analysis, TEM (transmission electron microscopy), SEM (scanning electron microscopy) or optical microscopy.

Having generally described this invention, a further understanding can be obtained by reference to certain specific examples which are provided herein for purposes of illustration only, and are not intended to be limiting unless otherwise specified.

### EXAMPLES

### Exemplary Embodiments

The figures below represent the following:

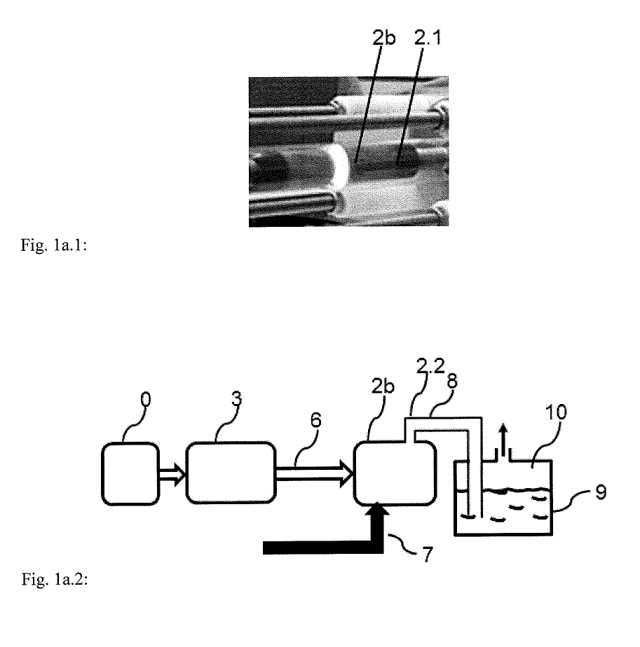

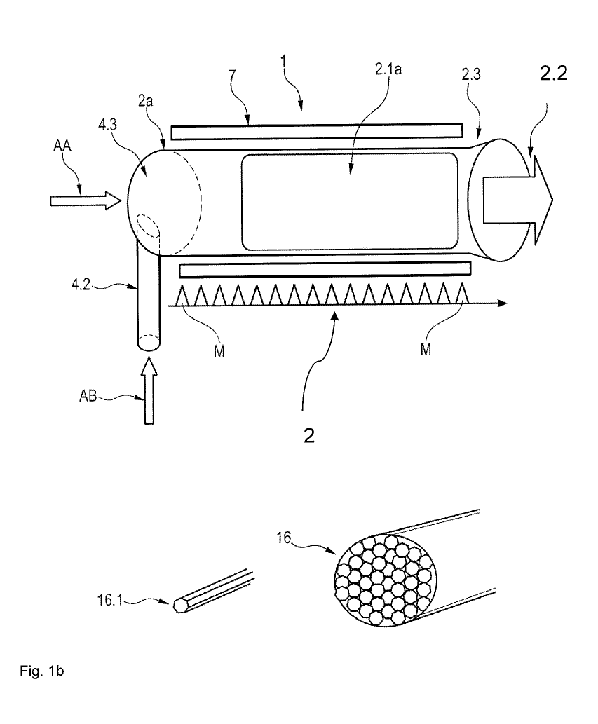

FIG. 1a.1: plasma reactor 2b

FIG. 1a.2: plasma reactor 2b with reactor 9 comprising the fluid organic compound

FIG. 1b: thermal reactor with millichannels

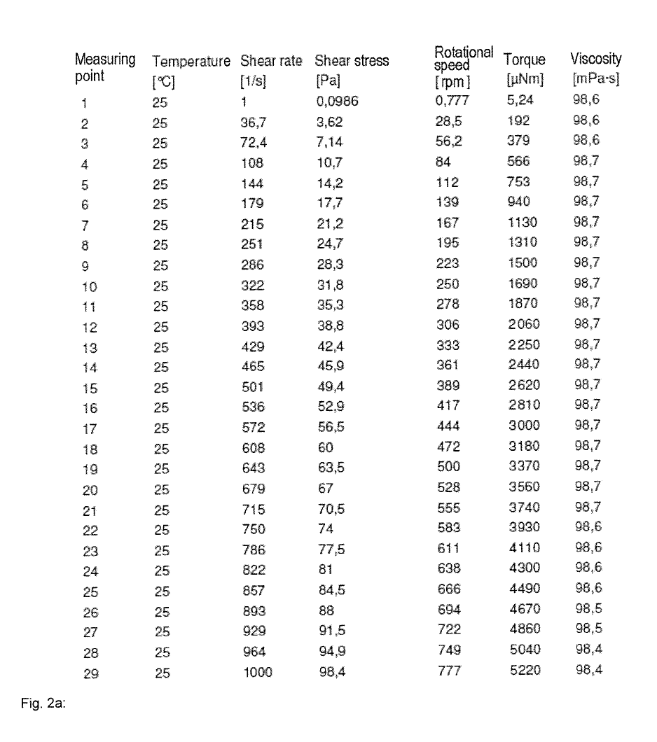

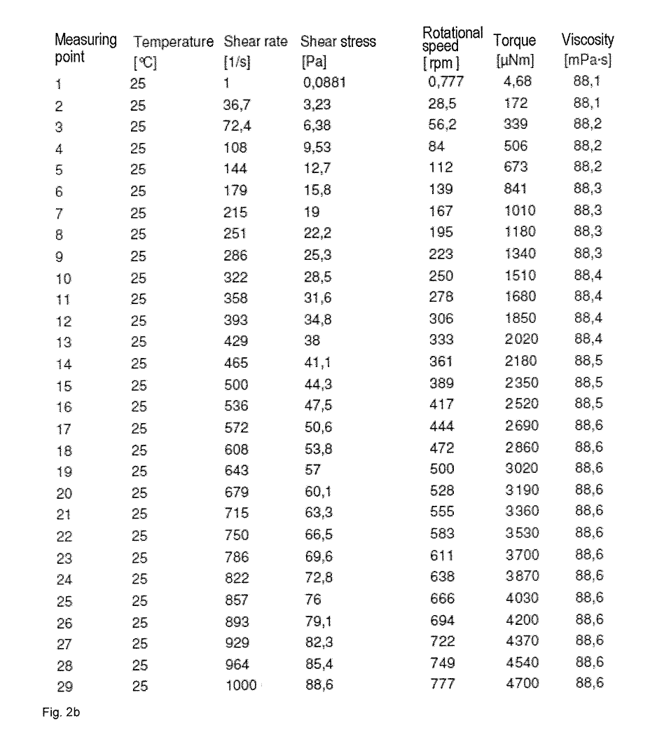

FIG. 2a: pure paraffin oil test series

FIG. 2b: paraffin oil with 0.5% Si-isopropanol test series

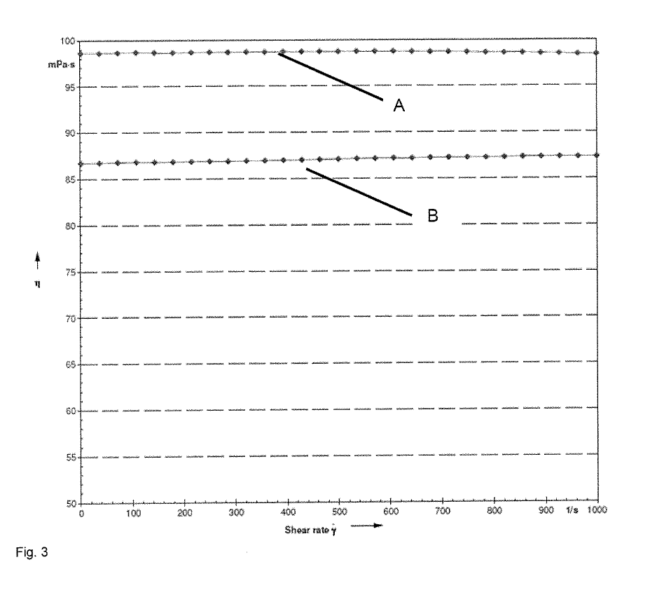

FIG. 3: plot of dynamic viscosity as a function of shear rate (A: paraffin oil without additive, B: paraffin oil with 0.5 wt % of functionalized silicon particles, in each case d=0 mm)

### Exemplary Embodiment 1: Plasma

5% monosilane in argon was processed via a plasma preferably with a large discharge gap and short residence time and thus subjected to a high-voltage pulse discharge. The process gas was then bubbled directly through the desired absorber solution, for example paraffin oil, thus precipitating the organofunctionalized silicon particles with corresponding surface tension. The obtained suspension comprising about 0.5 wt % of silicon proportions shows a viscosity reduction of the paraffin oil of about 15%.

### Exemplary Embodiment 2: Plasma

It has now been found that, completely surprisingly and unexpectedly, the object of the present invention was achieved when a monosilane mass flow composed of 1.5% monosilane in an argon matrix was treated and brought to reaction by means of a plasma operated in a non-thermal equilibrium in a plasma reactor 5 according to FIG. 1. In the inventive example, the reaction was effected continuously at a total volume flow of 3 standard litres per minute of process gas (at a concentration of 1.65 wt % of monosilane in argon). The process gas was brought to reaction in a reactor volume of phi cm³ (3.14 cm³) at an operating pressure of 1.17 bar absolute. This results in a residence time in the plasma of 0.073 seconds. The silicon particle resulting from the dehydrogenation of monosilane was formed by condensation from the gas phase and was highly reactive at the surface which was why it was introduced directly into a further reactor in which it could react further with a desired target molecule—in this case isopropanol. The primary particles typically had a diameter of 10 nm.

[Reactor data: Hemispherical electrode with geometric radius R=1 cm, half-shell counterelectrode having a geometric internal radius Ri of 1.1 cm, central outlet bore of 3 mm in diameter, 5 mm gap, electrode material graphite: half-shell area (OH): OH=4*phi*(R²)/2=6.28 cm². An electrode gap of 5 mm results in a plasma/reactor volume RV=OH*0.5 cm=6.28 cm²*0.5 cm=3.14 cm³/phi cm³.]; [residence time calculation: volume flow Vm=3 standard litres per minute=3000 cm³/min=50 cm3/s; operating pressure Pa=1.17 bar absolute, thus volume flow at operating pressure Va=Vm/Pa=50 cm³/s/1.17 bar abs=42.7 cm³/s. Residence time VWZ=RV/Va=3.14 cm³/42.7 cm³/s=0.073 s=73 milliseconds]

Increasing the pressure thus increased the residence time in the plasma. In the third inventive example, the operating pressure was increased to Pa=1.31 bar abs.

### Exemplary Embodiment 3—Plasma

1.6% monosilane in argon was brought to reaction by a non-thermal plasma at a volume flow of 3 standard litres per minute in the above-described discharge assembly with a plasma volume of about 3.14 cm³ at a pressure Pa of 1.31 bar absolute. The input power (La) determined by a measuring device known to one skilled in the art (1 in figure: Energiemeβgerät Brennenstuhl PM 231 E; Energiemeβgerät Brennenstuhl PM 231 E http://www.hornbach.de/data/shop/D04/001/780/494/651/38/8906749_Doc_01_DE_20140728162218.pdf;) was La=55.5 watts. The value was determined by subtracting the power consumption of the generator in plasma operation (157.7 watts) from the power consumption when idle (102.2 watts). For a geometric discharge volume of RV=3.14 cm³, the power density of the plasma reactor was La=55.5 watts divided by RV=3.14 cm³ and so LD=17.67 watts/cm³. For a volume flow of 38.17 cm³/s at Pa=1.31 bar absolute, the energy density for the processing was determined as La=55.5 watts divided by 38.17 cm³/s which equals 1.45 Ws/cm³. Power input was effected via high-voltage impulses with a full width at half maximum of T50=550 ns with a repetition rate of 3700.

The product stream was then bubbled directly through the desired isopropanol absorber solution, thus precipitating the organofunctionalized silicon particles with corresponding surface tension. The material recovered from the suspension by filtration shows a viscosity reduction for paraffin oil of about 15% for a silicon proportion of about 0.5 wt % (table in appendix).

0.5 wt % of the silicon particles functionalized with isopropyloxy compounds reduces the dynamic viscosity [mPas·s] in paraffin oil. The results are shown without additive in FIG. 2a and with additive in FIG. 2b. Addition of a small amount of 0.5 wt % of the silicon particles functionalized with propyloxy compounds reduced the viscosity of the paraffin by about 15% for the same shear rate and same rotational speed.

### LIST OF REFERENCE NUMERALS

0 220 Volt mains power consumption measuring unit
1 Reactor 1 (free-space infrared radiation reactor FIR)
2 Reaction cylinder (horizontal or vertical)
2a Horizontal reaction cylinder
2b Plasma reactor
2.1 Reaction space; 2.1a: Reaction zone, reaction zone 2.1a to 2.1n
2.2 Reactor cylinder outlet, in particular reactor tube outlet
2.3 Reactor cylinder outlet (with Venturi funnel) quench zone
3 Plasma generator
4.2 Tangential feed, in particular for circular gas flow in the reactor
4.3 Process gas feed with gas mixing unit
6 High-voltage and high-frequency connection to plasma reactor
7 Reactant volume flow
8 Product stream comprising dehydrated silicon particle target product
9 Surface-functionalization reactor (contains surface-functionalized silicon particle)
10 Residual gas consisting of argon and hydrogen for workup and recovery
16 Reactor insert with millichannels e.g. SiC frit
16.1 Millichannel section
M Measuring points in reactor
AA: Process gas/process gas mixture, AB: Process gas mixture e.g. monosilane/argon mixture, A: Paraffin oil without additive, B: Paraffin oil with 0.5 wt % of functionalized silicon particles

European patent application 16171252.6 filed May 25, 2016, is incorporated herein by reference.

Numerous modifications and variations on the present invention are possible in light of the above teachings. It is therefore to be understood that within the scope of the appended claims, the invention may be practiced otherwise than as specifically described herein.

1. Organofunctional silicon particles, comprising:
silicon particles which are covalently functionalized on their surface with at least one organic compound.

2. The silicon particles according to claim 1, wherein
the molecular weight of the organic compound is less than 600 g/mol.

3. The silicon particles according to claim 1, which are obtainable by introducing reactive silicon particles obtainable in situ in a plasmachemical process into an organic starting compound.

4. The silicon particles according to claim 3, wherein the organic starting compound is present as a gas or liquid at 1 bar and a temperature of not more than 100° C. or may be converted undecomposed into the liquid phase or gas phase, at a pressure of 10⁻⁵ bar to less than 1 bar and a temperature below 100° C.

5. The silicon particles according to claim 3, wherein
the organic starting compound is liquid and is at least one compound selected from group consisting of a monomeric organic compound, oxygen-comprising organic compounds, nitrogen-comprising organic compounds, sulfur-comprising organic compounds, halogen-comprising organic compounds or at least oxygen-, nitrogen- and/or sulfur-comprising organic compounds.

6. The silicon particles according to claim 1, wherein the organic compound is selected from the group consisting of —O—(C₁-C₄₈)-alkyl, —O—(C₆-C₂₀)-aryl,
—O—(C₁-C₄₈)-alkyl-(C₆-C₂₀)-aryl, —O—(C₆-C₂₀)-aryl-(C₁-C₄₈)-alkyl, —(C₆-C₂₀)-aryl,
—O—(C₁-C₁₂)-alkyl-O—(C₁-C₁₂)-alkyl, —O—(C₁-C₁₂)-alkyl-O—(C₆-C₂₀)-aryl,
—O—(C₆-C₂₀)-aryl-O—(C₁-C₁₂)-alkyl, —O—(C₆-C₂₀)-aryl-O—(C₆-C₂₀)-aryl,
—OC═O—(C₁-C₁₂)-alkyl, —S-alkyl, —S-aryl, —COO—(C₁-C₁₂)-alkyl,
—CONH—(C₁-C₁₂)-alkyl, —CO—(C₁-C₁₂)-alkyl, —CO—(C₆-C₂₀)-aryl, —N[(C₁-C₁₂)-alkyl]₂,
—(C₁-C₄₈)-alkyl, —(C₆-C₂₀)-aryl, —(C₁-C₄₈)-alkyl-(C₆-C₂₀)-aryl, and
—(C₆-C₂₀)-aryl-(C₁-C₄₈)-alkyl, wherein the alkyl and aryl groups may each independently be unsubstituted or substituted; substituted —(C₁-C₁₂)-alkyl groups and substituted —(C₆-C₂₀)-aryl groups may, depending on their chain length, comprise one or more substituents; the substituents may independently of one another be selected from —(C₃-C₁₂)-cycloalkyl, —(C₃-C₁₂)-heterocycloalkyl, —(C₆-C₂₀)-aryl, fluorine, chlorine, cyano, formyl, acyl and alkoxycarbonyl.

7. The silicon particles according to claim 6, wherein the organic compound
—O—(C₁-C₄₈)-alkyl is selected from the group consisting of —O—(C₁-C₁₂)-alkyl.

8. The silicon particles according to claim 1, wherein the surface of the silicon particles has a coverage factor Θ of the at least one organic compound (chem. adsorbed molecules N_{ads}) of 10 to 100 based on a monolayer coverage (Nₘₒₙₒ).

9. A process for producing organofunctional silicon particles covalently functionalized on their surface with at least one organic compound, comprising:
a) decomposing at least one gaseous or gaseous-at-elevated-temperature silicon compound
b) in the presence of a diluent gas in a substantially oxygen-free atmosphere in plasma or under thermal conditions, and
c) immediately introducing the silicon particles formed into at least one fluid organic starting compound or into a mixture comprising the at least one organic starting compound.

10. The process according to claim 9, wherein the
organic starting compound is selected from the group consisting of HO—(C₁-C₄₈)-alkyl, HO—(C₆-C₂₀)-aryl, HO—(C₁-C₄₈)-alkyl-(C₆-C₂₀)-aryl, HO—(C₆-C₂₀)-aryl-(C₁-C₄₈)-alkyl,
HO—(C₁-C₁₂)-alkyl-O—(C₁-C₁₂)-alkyl, HO—(C₁-C₁₂)-alkyl-O—(C₆-C₂₀)-aryl,
HO—(C₆-C₂₀)-aryl-O—(C₁-C₁₂)-alkyl, HO—(C₆-C₂₀)-aryl-O—(C₆-C₂₀)-aryl,
HOC═O—(C₁-C₁₂)-alkyl, HS-alkyl, HS-aryl, H—COO—(C₁-C₁₂)-alkyl,
H—CONH—(C₁-C₁₂)-alkyl, H—CO—(C₁-C₁₂)-alkyl, H—CO—(C₆-C₂₀)-aryl,
H—N[(C₁-C₁₂)-alkyl]₂, (C₁-C₄₈)-alkyl, (C₆-C₂₀)-aryl, (C₁-C₄₈)-alkyl-(C₆-C₂₀)-aryl,
and (C₆-C₂₀)-aryl-(C₁-C₄₈)-alkyl, wherein the alkyl and aryl groups may each independently be unsubstituted or substituted; substituted —(C₁-C₁₂)-alkyl groups and substituted —(C₆-C₂₀)-aryl groups may, depending on their chain length, comprise one or more substituents; the substituents may independently of one another be selected from —(C₃-C₁₂)-cycloalkyl, —(C₃-C₁₂)-heterocycloalkyl, —(C₆-C₂₀)-aryl, fluorine, chlorine, cyano, formyl, acyl and alkoxycarbonyl.

11. The process according to claim 9, wherein
i) gaseous or gaseous-at-elevated-temperature silicon compound comprises hydrogen- and/or halogen-comprising silanes and/or hydrocarbon-comprising silanes, halosilanes, chlorosilanes, H-silanes having no hetero atom substitution and/or at least one alkoxysilane, and/or
ii) the diluent gas comprises argon, helium, xenon, krypton, hydrogen or a mixture of at least two of the recited gases.

12. The process according to claim 9, wherein the plasma is a non-thermal plasma.

13. Silicon particles obtainable by a process according to claim 9, wherein the organofunctional silicon particles are functionalized on their surface with at least one organic compound covalently and/or by chemisorption with an organic compound.

14. A compound which is suitable as
a) an additive for reducing the viscosity of fluids,
b) a protectant for an industrial material protecting from electromagnetic radiation at the wavelength range of 10 to 1500 nm,
c) a UV protectant for an industrial material, surface, component, optoelectronic layer, or optoelectronic component,
d) a UV protectant from electromagnetic radiation, and/or
e) a protectant of biological cells from electromagnetic radiation at the wavelength range of 10 to 1500 nm;
said compound comprising the organofunctional silicon particles according to claim 1.

15. A composition, comprising:
the organofunctional silicon particles according to claim 1 as an additive or auxiliary in liquids, in liquid compositions, in pastes or pasty compositions, in emulsions, dispersions, suspensions, solutions, or gases.

16. The silicon particles according to claim 3, wherein the organic starting compound is a liquid, protic organic starting compound, at least one liquid hydrocarbon and/or a liquid mixture comprising a protic, organic starting compound and a hydrocarbon.

17. The silicon particles according to claim 5, wherein the organic compound is at least one compound selected from the group consisting of unsubstituted hydrocarbons, substituted hydrocarbons, carbohydrates, alcohols, thiols, ethers, amino acids, polyethers, carboxylic acid, fatty acids, fruit acids, halogenated hydrocarbons, halogenated alcohols, and halogenated polyethers.

18. The silicon particles according to claim 7, wherein the organic compound
—O—(C₁-C₄₈)-alkyl is selected from the group consisting of —OCH₃, —OC₂H₅, —O—C₃H₇, —O—C₄H₉, —O—C₅H₁₁, —O—C₆H₁₃, —O—C₇H₁₅, —O—C₈H₁₇, —O—C₉H₁₉, —O—C₁₀H₂₁, —O—C₁₁H₂₃, and —O—C₁₂H₂₃.

19. The silicon particles according to claim 7, wherein the organic compound
—O—(C₁-C₄₈)-alkyl is selected from the group consisting of —O-(iso-C₃H₇) —O-(n-C₃H₇), —O—C₄H₉, —O-(n-C₄H₉), —O-(iso-C₄H₉), —O-(tert-C₄H₉), and —O—C₄H₉.
